(19) United States
(12) Patent Application Publication
(10) Pub. No.: US 2012/0249793 A1
(43) Pub. Date: Oct. 4, 2012

(54) ON-BOARD CAMERA SYSTEM

(75) Inventor: Kazuyoshi OTSUKA, Yokohama-shi (JP)

(73) Assignee: Honda elesys Co., Ltd., Yokohama-shi (JP)

(21) Appl. No.: 13/413,294

(22) Filed: Mar. 6, 2012

(30) Foreign Application Priority Data
Mar. 7, 2011 (JP) 2011-049627

(51) Int. Cl. H04N 7/18

(52) U.S. Cl. 348/148; 348/E07.085

(57) ABSTRACT

An on-board camera system includes an imaging unit mounted in a vehicle to capture an image, a communication unit configured to perform information communication with test equipment using an OBD-II connection line; and an image compression unit configured to divide the image captured by the imaging unit into blocks with a predetermined number of pixels, to perform image compression of each image of the blocks, and to transmit the image of the blocks after image compression to the test equipment through the communication unit.

### CROSS-REFERENCE TO RELATED APPLICATIONS

Priority is claimed on Japanese Patent Application No. 2011-49627, filed Mar. 7, 2011, the contents of which are entirely incorporated herein by reference.

### BACKGROUND OF THE INVENTION

1. Field of the Invention

The present invention relates to an on-board camera system which monitors the area around a vehicle.

2. Description of Related Art

Conventionally, a vehicle periphery monitoring apparatus is known which monitors an area around a vehicle and which includes a camera that captures an area around a vehicle, a display device provided in the vehicle, and image processing means for encoding or decoding the image data captured by the camera using wavelet transform in order to display an image, which is obtained by capturing the area around the vehicle, on the display device provided in the vehicle. In recent years, the mounting of an on-board camera system, which uses a moving image in order to acquire the peripheral information, in a vehicle is increasing. According to such an on-board camera system, in a situation in which the left and right sides of an intersection that a driver is approaching are not visible due to obstacles on the left and right sides of the driver's seat, an image in front of the vehicle is displayed on the display device so that the conditions at the intersection can be checked (for example, refer to JP-A-2005-303450).

### SUMMARY OF THE INVENTION

Incidentally, as shown in FIG. 11, when recording a captured image output from a front monitoring camera unit in the conventional on-board camera system, the captured image is output according to the analog video signal format, such as NTSC (National Television System Committee) or PAL (Phase Alternating Line), and the image is captured and saved using test equipment (test equipment for repair shops) or equipment such as a combination of a personal computer and a capture board, so that optical axis adjustments or maintenance and inspection at the time of replacement, installation, and the like of the on-board camera system can be performed.

However, in order to extract an image according to the analog video signal format such as NTSC or PAL as in the conventional on-board camera system, it is necessary to provide a dedicated device or a dedicated circuit for conversion into an NTSC or PAL signal in the camera unit. Accordingly, there is a problem in that a lack of versatility is caused by issues such as having to prepare a dedicated signal acquisition fixture rather than the standard automobile manufacturer test equipment as equipment for acquisition of an image. It is preferable that the tester connection signal OBD-II (On Board Diagnostic-2), which is the current international standard, be used for signal connection.

However, when transmitting an image using the international standard tester connection signal OBD-II, there is a problem in that it takes a long communication time to transmit an image with a large amount of data since the communication speed of the tester connection signal OBD-II is low and this is not suitable for practical use. When transmitting an original image output from the on-board camera system as it is, the size becomes 318816 bytes even in the VGA size monochrome RAW image data. Since it takes about 6 minutes and 7 seconds to transmit the image data through the K-Line (communication speed=10.4 kbps) of OBD-II, there is a problem in that a large amount of time is required to perform the test.

The present invention has been made in view of such a situation, and it is an object of the present invention to provide an on-board camera system capable of transmitting the data of an image required to perform maintenance, inspection, and the like using the tester connection signal OBD-II, which is the international standard, for an on-board camera unit that does not have enough resources to perform full-scale image conversion processing.

A first aspect of the present invention is an on-board camera system including: an imaging unit mounted in a vehicle to capture an image; a communication unit configured to perform information communication with test equipment using an OBD-II connection line; and an image compression unit configured to divide the image captured by the imaging unit into blocks with a predetermined number of pixels, to perform image compression of each image of the blocks, and to transmit the image of the blocks after image compression to the test equipment through the communication unit.

In the on-board camera system described above, the image compression processing by the image compression unit and compressed image transmission processing by the communication unit may be performed in parallel.

In the on-board camera system described above, the imaging unit may be configured to capture an image in front of the vehicle, and the image compression unit may be configured to perform image compression of an image obtained by trimming a periphery of the front image so that at least a road surface of a lane, along which a host vehicle travels, and a portion, in which an object to be monitored is reflected, remain.

In the on-board camera system described above, the image compression unit may be configured to perform image compression using JPEG.

According to the present invention, an effect that the data of an image required to perform maintenance, inspection, and the like can be transmitted to test equipment using tester connection signal OBD-II, which is the international standard, is obtained.

### BRIEF DESCRIPTION OF THE DRAWINGS

FIG. 1 is an outline view showing the appearance of a vehicle in an embodiment of the present invention.

FIG. 2 is a block diagram showing the configuration of an on-board camera system according to an embodiment of the present invention.

FIG. 3 is an explanatory view showing the processing operation of an image compression unit shown in FIG. 1.

FIG. 4 is an explanatory view showing the processing operation of the image compression unit shown in FIG. 1.

FIG. 5 is an explanatory view showing the processing operation of the image compression unit shown in FIG. 1.

FIG. 6 is an explanatory view showing the processing operation of the image compression unit shown in FIG. 1.

FIG. 7 is an explanatory view showing the processing operation of the image compression unit shown in FIG. 1.

FIG. 8 is a view showing an example of an original image captured by a camera shown in FIG. 1.

FIG. 9 is an explanatory view showing the relationship between the image compression rate and transmission time.

FIG. 10 is a view showing an example of a compressed image output from the image compression unit shown in FIG. 1.

FIG. 11 is an external view showing the configuration of a conventional on-board camera system.

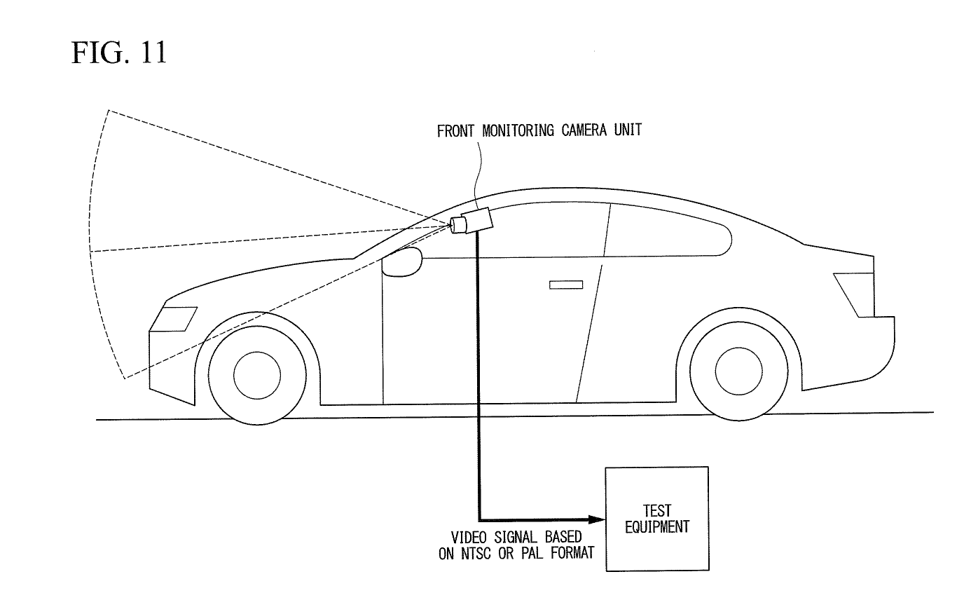

### DETAILED DESCRIPTION OF THE INVENTION

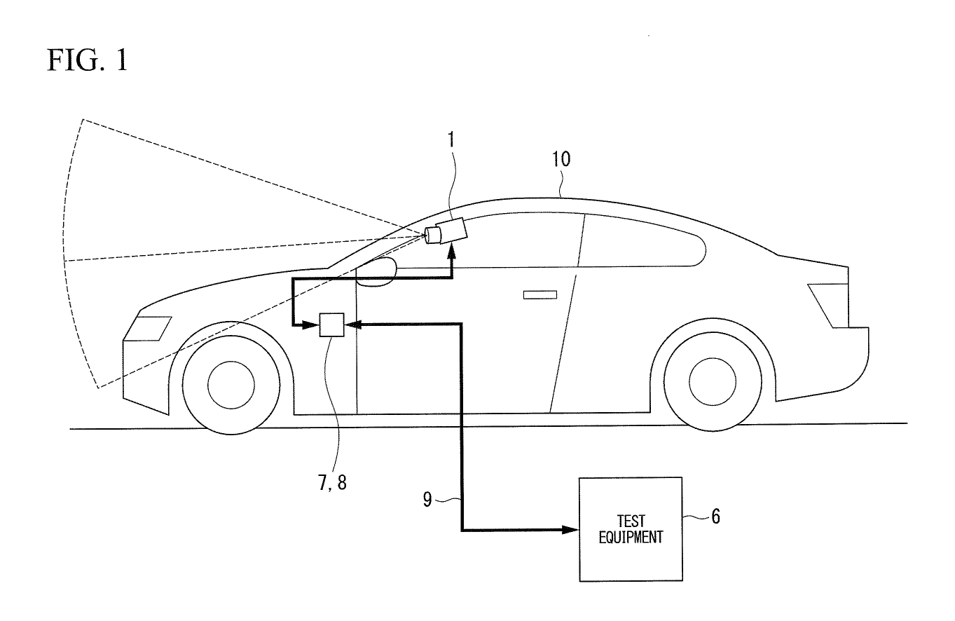

Hereinafter, an on-board camera system according to an embodiment of the present invention will be described with reference to the drawings. FIG. 1 is a view showing the appearance of a vehicle 10 in which an on-board camera system (camera unit) is mounted in the same embodiment. In this drawing, reference numeral 1 is a camera unit which captures an image in front of the vehicle 10. Although a configuration where the camera unit 1 captures an image in front of the vehicle 10 is shown herein, images captured by the camera unit 1 are not limited to images in front of the vehicle 10, and the side of the vehicle 10, the back of the vehicle 10, and the interior of the vehicle 10 may be captured. Reference numeral 6 is test equipment for testing the vehicle 10. The test equipment 6 performs processing, such as recording or display of an image output from the camera unit 1. Reference numerals 7 and 8 are service connectors for connecting the camera unit 1 and the test equipment 6 to each other using an OBD-II connection line 9. The vehicle-side service connector 7 may be a connector which is typically provided in the vehicle 10.

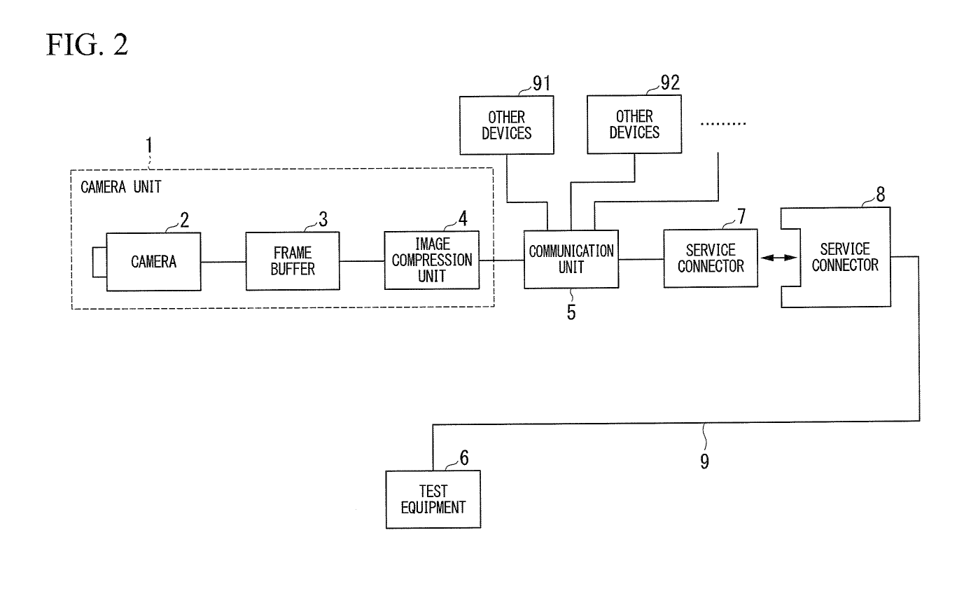

Next, a detailed configuration of the on-board camera system according to an embodiment of the present invention will be described with reference to FIG. 2. FIG. 2 is a block diagram showing the configuration of the on-board camera system of the present invention. In FIG. 2, explanation will be given in a state where the same reference numerals are given to the same components as in the configuration shown in FIG. 1. In FIG. 2, reference numeral 1 is a camera unit. Reference numeral 2 is a camera which captures a color image or a monochrome image. Reference numeral 3 is a frame buffer which stores one frame of an image output from the camera 2. Reference numeral 4 is an image compression unit which compresses an image of one frame stored in the frame buffer 3 and outputs a compressed image. Reference numeral 5 is a communication unit which performs information communication by OBD-II connection between other devices 91 and 92 to be tested which are mounted in the camera unit 1 and the vehicle 10, respectively, and the test equipment 6. Reference numeral 6 is test equipment which performs maintenance and inspection of the camera unit 1, other devices 91 and 92, and the like mounted in the vehicle 10. Reference numeral 7 is a service connector which is connected to the communication unit 5 through a communication line and which is provided on the vehicle side in order to perform testing using the OBD-II connection line 9. Reference numeral 8 is a service connector on the test equipment 6 side, which is connected to the test equipment 6 through the OBD-II connection line 9, and is connectable to the service connector 7.

Next, an operation of the on-board camera system will be described with reference to FIG. 2. First, when performing maintenance and inspection of the camera unit 1, the operator connects the service connector 8 connected to the test equipment 6 to the service connector 7 provided in the vehicle 10. Then, when the operator gives an instruction to capture an image signal of the camera unit 1 on the test equipment 6, the test equipment 6 sends to the camera unit 1 a request for transmission of the image signal. This transmission request is sent to the camera unit 1 through the communication unit 5. The camera 2 operates in response to this request and starts capturing of an image. The image output from the camera 2 is stored in the frame buffer 3 for each frame. When a new image is stored in the frame buffer 3, the image compression unit 4 performs image compression processing on the image stored in the frame buffer 3 and transmits the compressed image to the test equipment 6 through the communication unit 5.

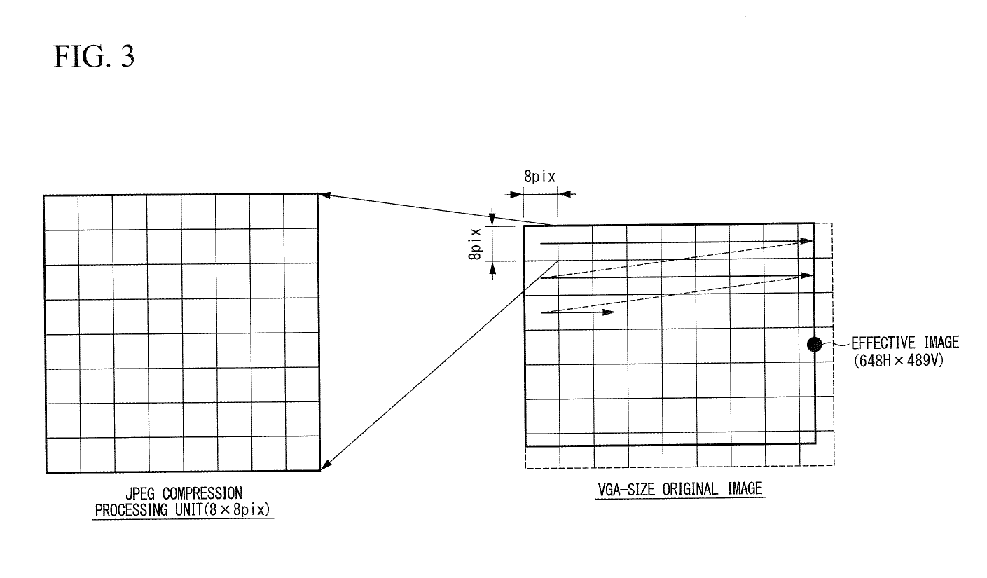

Here, an image compression processing operation of the image compression unit 4 will be described. The image compression unit 4 performs image compression using the JPEG (Joint Photographic Experts Group). The JPEG image compression function is standardized by JIS-X4301, CCITT T.81 (09/92) [ITU], or the like. However, there is a problem in that memory resources of the camera unit 1 are not sufficient if these specifications are applied to the image compression unit 4 as they are. Therefore, as shown in FIG. 3, by dividing one frame of an image, which needs to be transmitted, into blocks of 8×8 pixels, omitting the optimization of the Huffman table and the like over the entire screen and avoiding dynamic Huffman compression for which resources are needed, and performing completed and simple JPEG compression sequentially from the upper left of the screen, the problem of insufficient resources is solved.

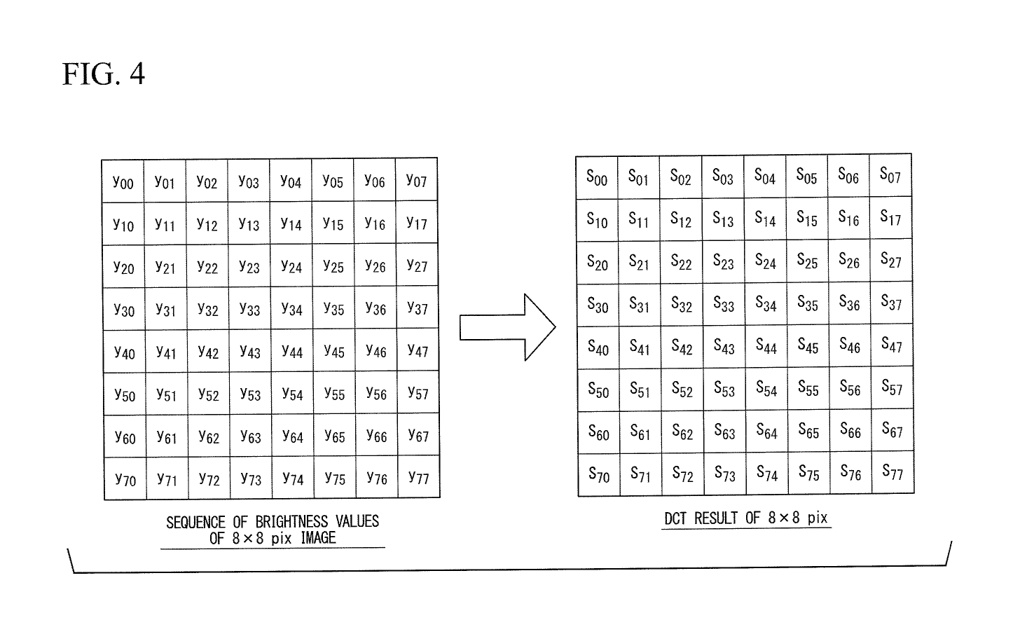

First, the image compression unit 4 divides an image stored in the frame buffer 3 into 8×8 pixels and subtracts 127 from the brightness value y_{org ji} (≧0) of the divided 8×8 pixels (yⱼᵢ=y_{org ji}−127). Then, from Equation (1), discrete cosine transform (DCT) is performed on a result obtained by converting all elements into AC values (values distributed on positive or negative sides with zero as the center) (refer to FIG. 4). Since discrete cosine transform processing is well-known, detailed explanation thereof will be omitted.

$$Svu = \frac{1}{4} {C}_{u} \cdot {C}_{v} {\sum }_{i = 0}^{7} {\sum }_{j = 0}^{7} {y}_{ji} cos \frac{( 2 i + 1 ) u π}{16} cos \frac{( 2 j + 1 ) v π}{16} \\ where \text{:} \\ {C}_{0} = \frac{1}{\sqrt{2}} \\ else \text{:} \\ {C}_{x} = 1 \qquad ( 1 )$$

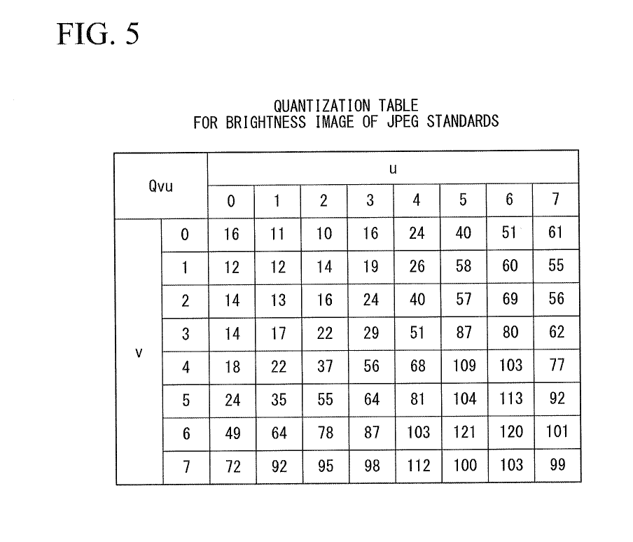

Then, the image compression unit 4 performs quantization. In this case, in order to optimize a quantization table, a standard table written in the JPEG standards is used and quantization is performed using Equation (2) as shown in FIG. 5, since a large amount of memory and processing time are wasted for one frame. Accordingly, the waste of a large amount of memory and processing time can be prevented.

$${r}_{vu} = ( int ) \frac{{S}_{vu} \times q}{{Q}_{vu}} \qquad ( 2 )$$

Sᵥᵤ: DCT transform result
rᵥᵤ: quantization result
Qᵥᵤ: standard quantization table
q: quantization quality (Tq value of DQT segment)

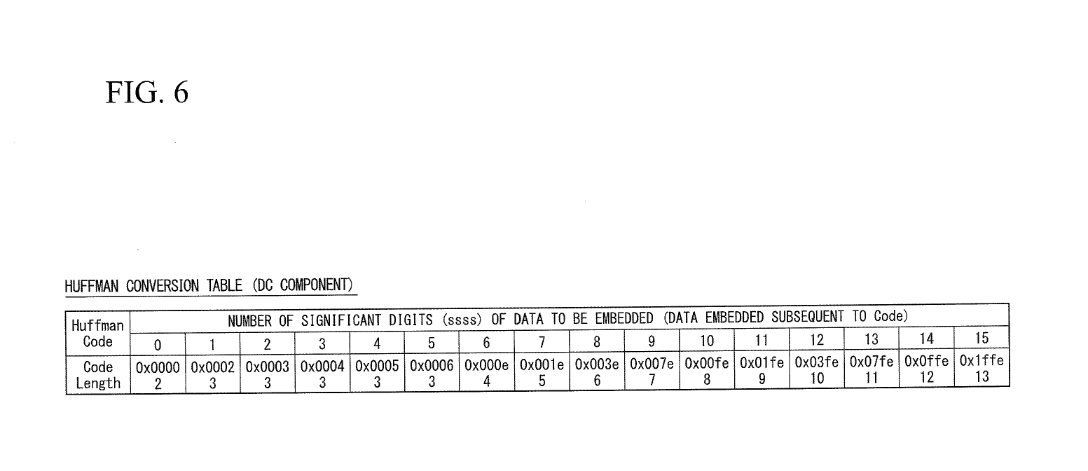

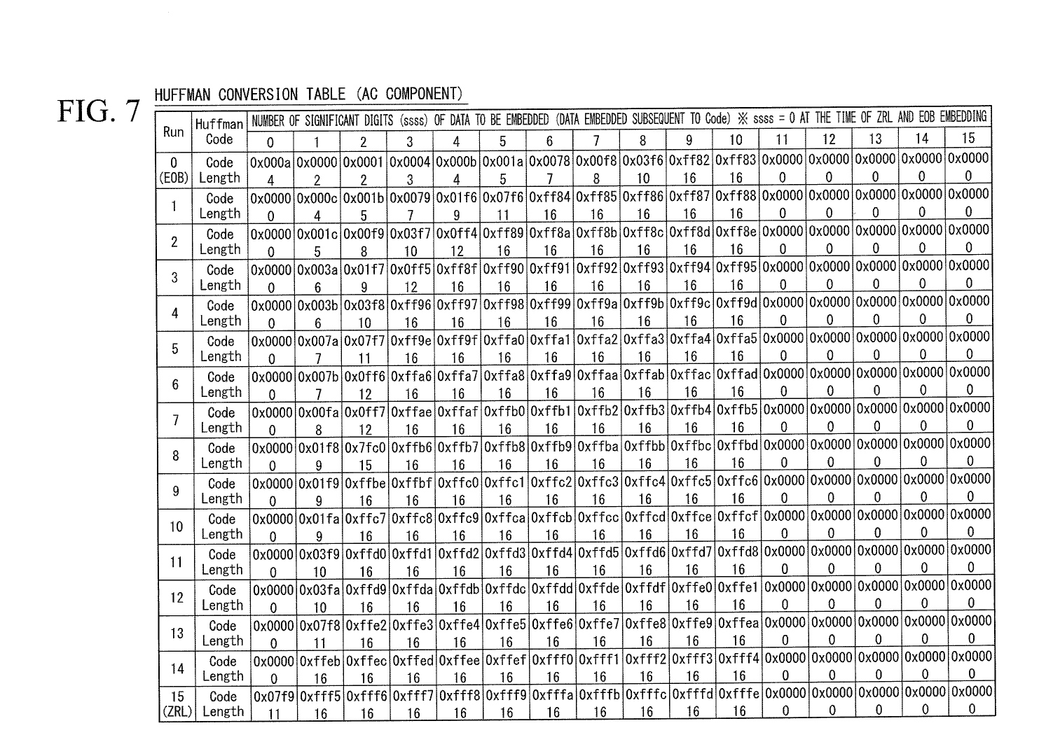

Then, the image compression unit 4 performs static Huffman conversion. First, for a DC component (S00), the image compression unit 4 performs Huffman conversion of the DC component (S00) for a difference from the previous value (value of a DC component of a previous block). Then, Huffman conversion of AC components (S01 to S77) is performed in order of a zigzag scan. In this case, in order to optimize a DC/AC Huffman conversion table, a standard Huffman conversion table written in the JPEG standards is used as shown in FIGS. 6 and 7, since a large amount of memory and processing time are wasted for one frame. Since the Huffman conversion table shown in FIGS. 6 and 7 is well-known, detailed explanation thereof will be omitted herein.

Then, the image compression unit 4 transmits the obtained result (compression result of 8×8 pixels) to the test equipment 6 through the communication unit 5. In this case, the image compression unit 4 performs compression processing on the next 8×8 pixels to perform image compression of one frame and transmission processing of the compressed image in parallel with the output of the compressed data of 8×8 pixels from the image compression unit 4 to the communication unit 5 and transmission of the compressed data of 8×8 pixels to the test equipment 6 through the communication unit 5. Accordingly, the waste of a large amount of memory in the image compression unit 4 can be prevented.

Then, the image compression unit 4 repeats the above processing operation whenever the frame buffer 3 is updated with a new image, and transmits the compressed image to the test equipment 6. The operator operates the test equipment 6 to display the image transmitted from the camera unit 1 on a display device of the test equipment 6 and checks it visually or records it on a recording device.

Thus, since the image can be separately processed in units of a small block, it is possible to shorten the time until the transmission of the first block after receiving an image transmission instruction from the test equipment 6. In addition, since the next block can be converted in the image compression unit 4 while the communication unit 5 transmits the image data of one block, transmission can be continued without interruption.

Moreover, in the above explanation, an example where images of one frame are transmitted in order has been described. In order to shorten the transmission time further, however, a predetermined number of pixels of an original image may be thinned out or the capacity of the original image may be reduced to shorten the transmission time. In addition, when it is necessary to improve the image quality, the size of an original image may be reduced by trimming unwanted parts, such as the periphery of an image, in order to improve the image quality. Also in this case, the image quality can be improved while maintaining the size after JPEG conversion.

In addition, when the transmission of a moving image is necessary, it is necessary to compress the image further. In this case, it is possible to reduce the size of an original image and then to perform JPEG compression and transmit it, so that the data is expanded as a motion JPEG. In addition, a reference cursor may be overlay-displayed for the purpose of service check and adjustment check.

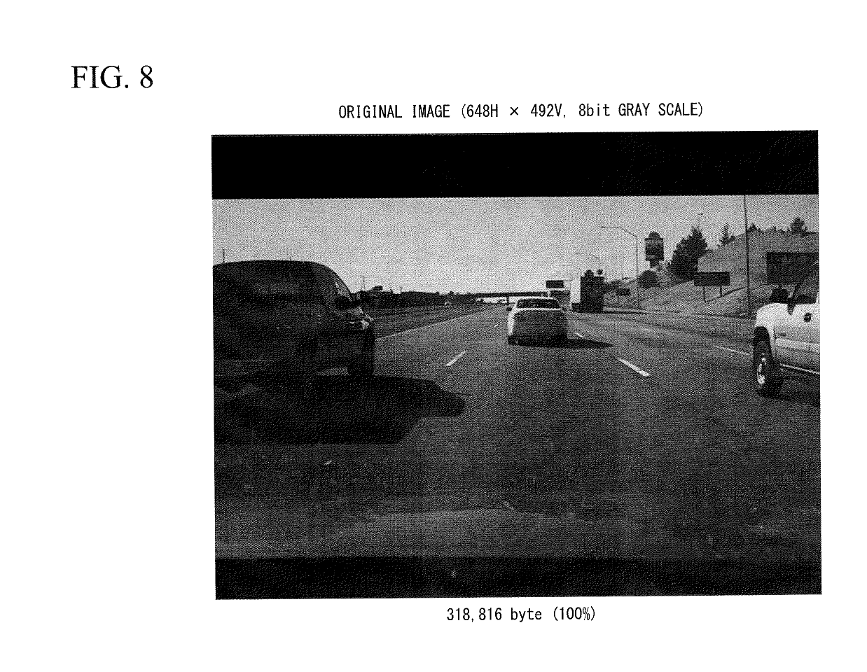

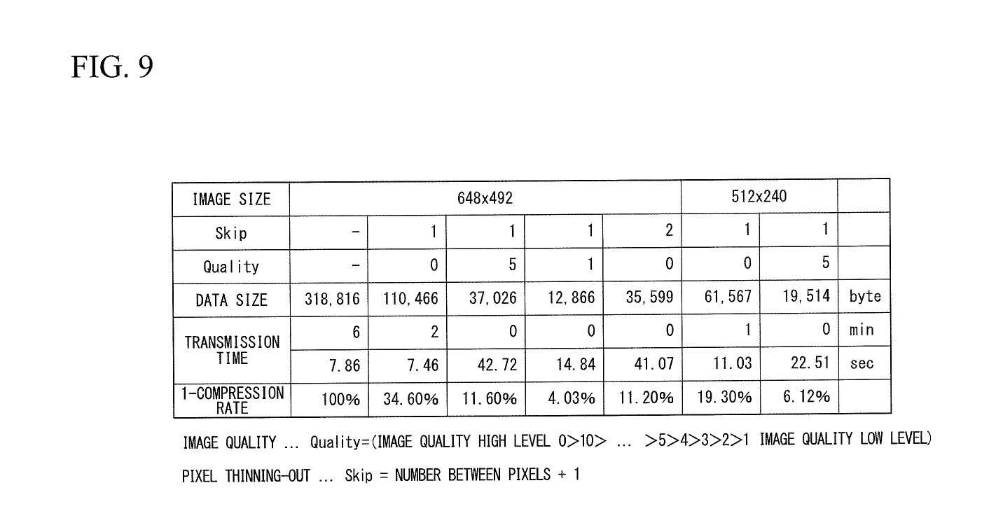

Next, the relationship between the image compression rate and transmission time in the camera unit 1 shown in FIG. 1 will be described with reference to FIGS. 8 to 10. FIG. 8 shows an original image captured by the camera 2. This image includes 648 pixels vertical×492 pixels horizontal, and one pixel is expressed in an 8-bit gray scale. The size of the original image is 318816 bytes. FIG. 9 is a view showing the relationship between the image compression rate and transmission time.

As shown in FIG. 9, it takes 6 minutes and 7.86 seconds (367.86 seconds) to transmit 1 frame of a VGA-size still image through the K-Line of OBD-II. However, it takes 2 minutes and 7.46 seconds (127.46 seconds) which is about ⅓ of 367.86 seconds in conditions in which there is no pixel thinning-out (Skip=1) and the quality is at a high level (Quality=0), it takes 42.72 seconds which is about 1/9 of 367.86 seconds in conditions in which there is no pixel thinning-out (Skip=1) and the quality is at a medium level (Quality=5), it takes 14.84 seconds which is about 1/25 of 367.86 seconds in conditions in which there is no pixel thinning-out (Skip=1) and the quality is at a low level (Quality=1), and it takes 41.07 seconds which is about 1/10 of 367.86 seconds in conditions in which there is one pixel thinning-out (Skip=2) and the quality is at a high level (Quality=0). In addition, it takes 1 minute and 11.03 seconds (71.03 seconds) which is about ⅕ of 367.86 seconds in conditions in which there is periphery trimming (512 H×240 V), there is no pixel thinning-out (Skip=1), and the quality is at a high level (Quality=0), and it takes 22.51 seconds which is about 1/16 of 367.86 seconds in conditions in which there is periphery trimming (512 H×240 V), there is no pixel thinning-out (Skip=1), and the quality is at a medium level (Quality=5). Thus, the transmission time can be shortened in proportion to the image compression rate by compressing an image and transmitting it. Accordingly, the operation is only slightly influenced even if the K-Line of OBD-II is used.

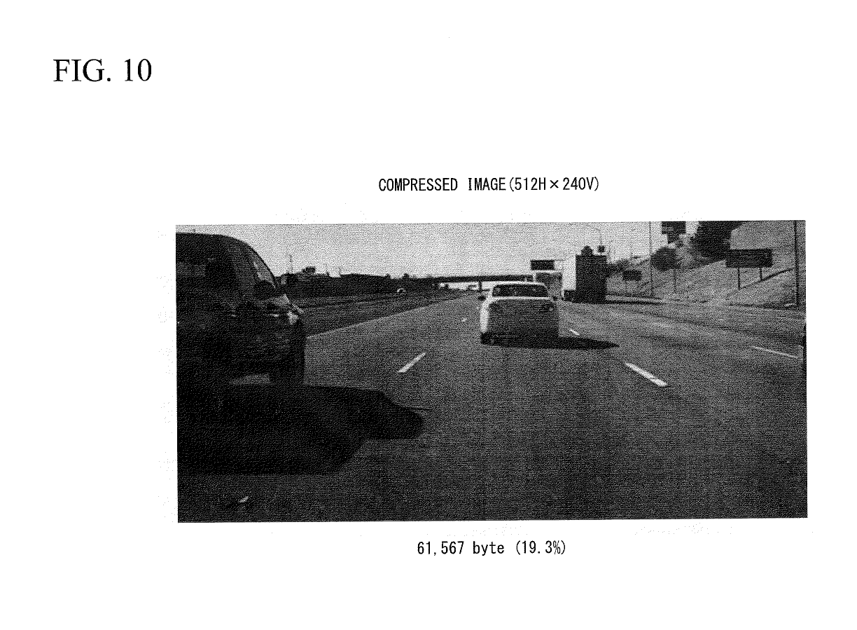

Among the image compression methods shown in FIG. 9, a result of image compression in conditions in which there is periphery trimming (512 H×240 V), there is no pixel thinning-out (Skip=1), and the quality is at a high level (Quality=0) is shown in FIG. 10. In an on-board camera system which monitors the front of the vehicle 10, such as the camera unit 1 for front monitoring shown in FIG. 1, it is possible to test the camera unit 1 if at least the road surface of the lane along which the host vehicle is traveling and a vehicle ahead, which is an object to be monitored, are reflected on the image. For this reason, it is optimal to transmit an image (image obtained by trimming the periphery with the optical axis as its center and thinning out pixels) shown in FIG. 10. The image transmission time based on image compression is about 1 minute, which is a reasonable amount of time for testing. Accordingly, the transmission time can be set within a range that does not affect test operation.

In addition, in the case of transmission based on Diagnostic Communication on CAN (500 kbps), the transmission time per frame can be set to 1/50. As a result, it becomes possible to transmit a moving image.

As described above, the on-board camera system according to the present invention is formed by a camera unit for front monitoring or the like, an international standard OBD-II service connector, and test equipment. In addition, the camera unit is made to perform compression processing and transmission processing of image data in parallel when performing an image compression function optimized for the resources of the unit and transmitting the image data using an OBD-II connection line. Accordingly, it is possible to make a signal connection through the international standard OBD-II service connector. As a result, it is possible to use standard equipment, such as standard test equipment, and also to obtain an image by just making a connection to the OBD-II service connector, which is typically provided, without providing a connector for obtaining an image. Moreover, since an image to be transmitted is transmitted in a compressed state using an image compression function, such as JPEG, image transmission can be performed in a range that does not affect a test operation even if the K-Line of OBD-II having a low communication speed is used.

In addition, although an example where JPEG is used as an image compression method has been described in the above, the image compression method is not limited to JPEG and other image compression methods may be applied.

Programs for realizing the functions of the image compression unit 4 in FIG. 2 may be recorded on a computer-readable recording medium, and the programs recorded on the recording medium may be read and executed by a computer system to perform the image compression and the image transmission. The “computer system” herein includes an OS and hardware such as peripherals. The “computer-readable recording medium” includes a portable medium such as a flexible disc, a magneto-optical disc, a ROM, or a CD-ROM or a storage device such as a hard disk built in the computer system. The “computer-readable recording medium” also includes a device storing a program for a predetermined time, like an internal volatile memory (RAM) of a computer system serving as a server or a client when the program is transmitted through a network such as the Internet or a communication line such as a telephone line.

The programs may be transmitted from a computer system having the programs stored in a storage device thereof or the like to another computer system through a transmission medium or by carrier waves in the transmission medium. The “transmission medium” which transmits a program means a medium having a function of transmitting information and examples thereof include a network (communication network) such as the Internet and a communication link (communication line) such as a telephone line. The program may realize some of the above-described functions. The program may realize the above-described functions in combination with a program already recorded in a computer system, that is, the program may be a differential file (differential program).

What is claimed in:

1. An on-board camera system comprising:
an imaging unit mounted in a vehicle to capture an image;
a communication unit configured to perform information communication with test equipment using an OBD-II connection line; and
an image compression unit configured to divide the image captured by the imaging unit into blocks with a predetermined number of pixels, to perform image compression of each image of the blocks, and to transmit the image of the blocks after image compression to the test equipment through the communication unit.

2. The on-board camera system according to claim 1,
wherein image compression processing by the image compression unit and compressed image transmission processing by the communication unit are performed in parallel.

3. The on-board camera system according to claim 1,
wherein the imaging unit is configured to capture an image in front of the vehicle, and
the image compression unit is configured to perform image compression of an image obtained by trimming a periphery of the front image so that at least a road surface of a lane, along which a host vehicle travels, and a portion, in which an object to be monitored is reflected, remain.

4. The on-board camera system according to claim 1,
wherein the image compression unit is configured to perform image compression using JPEG.
